(19) United States
(12) Patent Application Publication
(10) Pub. No.: US 2022/0092842 A1
(43) Pub. Date: Mar. 24, 2022

(54) LOCK OUT/TAG OUT CONTROL

(71) Applicant: Roberto Cossa LEVY, West Des Moines, IA (US)

(72) Inventor: Roberto Cossa LEVY, West Des Moines, IA (US)

(21) Appl. No.: 17/369,006

(22) Filed: Jul. 7, 2021

Related U.S. Application Data
(60) Provisional application No. 63/080,794, filed on Sep. 21, 2020.

(51) Int. Cl. G06T 13/80; G06T 11/60; G06T 11/20; G06F 30/20; G06F 3/0482

(52) U.S. Cl. CPC G06T 13/80; G06T 11/60; G06F 2111/20; G06F 30/20; G06F 3/0482; G06T 11/20

(57) ABSTRACT

A method, system and computer program product for providing and controlling lock out/tag out and energization status information in a visual manner using animated single line diagrams.

### CROSS-REFERENCE TO RELATED APPLICATIONS

This application claims the benefit of U.S. Provisional Application No. 63/080,794 filed Sep. 21, 2020, entitled “Lock Out/Tag Out Control” the contents of which are hereby incorporated by reference in their entirety.

### TECHNICAL FIELD

The present invention relates generally to a method for locking and tagging out. More particularly, the present invention relates to a method for controlling lock out tag out operations.

### BACKGROUND

Various projects in industry and research settings need systems to be tested. For example, as a building or system is being built, there may be complex electrical, mechanical and piping systems that have to be tested. This happens in mission critical facilities, data centers, petrochemical plants, hospitals, medical facilities, laboratories, power plants, nuclear facilities, manufacturing facilities, government facilities and any other building that may contains hazardous energy sources that supply power to a piece of equipment, machinery or system.

Hazardous energy sources include, but are not limited to, electrical, hydraulic, pneumatic, chemical, thermal or mechanical energy. Equipment that need to be isolated usually have an energy isolation device that is put in an off position to shut down the hazardous energy source. Physical restraints (such as lock out devices) are then put onto the energy isolation device and secured, for example, with padlocks. Examples of Lock Out Devices include ball valve and gate valve lock outs, circuit breaker lockouts, plug and wall switch lock outs and pneumatic lock outs. The total shutdown and restraint of all hazardous energy sources including the safe release of stored hazardous energy (e.g. capacitors and pressure in a line) must be accounted for.

There is currently no way of knowing in real time, what equipment or system is turned on during such projects. There is also no way of knowing in real time which equipment has been energized for the first time and which breakers have been locked out tagged out (LOTO'd).

Current systems provide checklists for lock out tag out processes. Users don't like reading purely text checklists. Other solutions involve printing barcodes for identifying devices, which is error prone as barcodes can be accidentally switched before being applied to a device and are not human readable.

At construction sites, there is also no efficient way of knowing which breakers are locked out and tagged out unless you look at a paper log at the construction site. Paper logs are not easily available to construction teams when they need to work on a piece of equipment. Project managers have to sometimes contact several team members to access this information as there usually is no central digital repository that displays this information in a visually intuitive manner.

There is a need to have a software and system and process that structures lock out tag out program for construction professionals, facility managers and owners. In addition, there needs to be a way for professionals to trust that the system is working well. Professionals don't always trust the software and need to verify software functions by checking it against a different system. Projects such as construction projects change very quickly and need to be easily updated as the project conditions and design changes occur.

### SUMMARY

The illustrative embodiments provide a method, system, and computer readable media for generating a lockout tag out display illustrative of a lock out tag out status of a device.

Safety professionals, project managers, commissioning staff and owners want to know which equipment is being worked on. The software system needs to be able to report this data in an easy intuitive manner that gives a visual overview of how the construction is progressing, what equipment to caution/avoid being near, what areas of the building to caution and plan out what the next step is in the commissioning process.

It is desirable to have a system that can not only display the schematics for people to see but to test the mechanical, electrical and piping/plumbing system and see how it will react to devices/breakers being shut off or turned on, valves shut off and turned on. Doing this quickly and seeing changes to the energy status of each equipment allows for a greater understanding of the project/building/facility by its stakeholders.

For example, in construction, one can test to see if a certain electrical equipment will maintain power during a construction sequence in a building. It is desirable to effectively communicate this to other users in a construction project so they have up to date information on when power will be available.

It is also desirable, when locking out tagging out to know what equipment and building locations your lock out tag out will be affecting. It is desirable to have a system where one can easily find the device to be locked out tagged out in the single line diagram. There is also a need to easily and quickly find that device in the design drawing floor plans and in the building information model. There is a desire for users/construction workers to be able to easily find the location of equipment that is currently being worked on to avoid standing in dangerous areas. For example, in construction, if one can test to see if a certain electrical will have maintain power during a construction sequence in a building. You can analyze this manually, but it is desirable to effectively communicate this to other trades in a construction project so they have up to date information on when power will be available. It is also desirable, when locking out tagging out to know where your lock out tag out will be affecting. It is desirable to have a system where you can easily find the breaker/device you are looking to lockout tag out in the single line diagram.

There is also a need to easily and quickly find that device in the design drawing floor plans and in the building information model. There is a desire for construction workers to be able to easily find the location of equipment that is currently being worked on to avoid standing in dangerous areas.

An embodiment allows the creation of a single line diagram on a user interface that is updated in real time to illustrate the lock out tag out statuses of devices in a system.

An embodiment includes a method for managing a lock out tag out processes by tracking lock out tag out activities and allowing the search of a user interface activity history. For example, a breaker is closed (connected), software logs data associated with the closure such as who closed it, what time it was closed, breaker identification/text/number(ID) and browses automatically to a portion of the user interface where the breaker is located. It can also filter search results based on what activity the user wants to see. For example, the user wants to see all activities of another user, or each device that has been energized for the first time (first time energizations). The activity log can be used to investigate incidents that have occurred.

Another embodiment allows the visualization of labels of equipment when zooming in or out of the user interface, i.e. text labels are resized based on the level of zoom such that the text labels remain readable.

In an illustrative embodiment, a computer implemented method for generating a lockout tag out display is provided, the method includes; providing a user interface with the lock out tag out display; receiving on the user interface a design drawing of a physical space containing the device; creating an animated single line diagram on the user interface based on the design drawing; receiving a lockout tag out status instruction for the device; and carrying out a lockout tag out status operation on the device in the single line diagram based on the received lockout tag out status instruction.

In another illustrative embodiment of the present invention, the method includes one or more of the following: (i) wherein a server distributes said lockout tag out status instruction to a plurality of clients, (ii) wherein the animated single line diagram is created automatically using pattern recognition wherein components of the design drawing are automatically recognized and corresponding objects are chosen from a predefined database of objects to create the animated single line diagram, (iii) wherein the animated single line diagram is created manually by identifying components of the design diagram and selecting corresponding objects from a predefined database of objects to create the animated single line diagram, (iv) wherein the animated single line diagram is created semi-automatically by a combination of manual and automatic steps, (v) further comprising receiving an image from a user representative of an identification of said device and obtaining said identification from analysis of the image, (vi) wherein the animated single line diagram is overlaid on the design drawing, (vii) further comprising: computing an effect of the lockout tag out status operation on other devices upstream and downstream of the device based on defined energy flow logic, (viii) wherein virtual objects in the animated single line diagram are animated by coloring, shading, reorienting, moving, or making them transparent, (ix) further comprising displaying virtual objects corresponding to physical devices that have been first time energized and/or energized based on stored information about energizations of the physical devices, (x) displaying virtual objects corresponding to physical devices that have been locked out tagged out based on stored information about lock out tag out statuses of the physical devices, (xi) further comprising providing a test mode for the user interface wherein changes to virtual objects of the animated single line diagram are controlled on a local user interface, (xii) further comprising providing a list of activities and/or devices that match a user search criteria, wherein responsive to selecting an activity and/or device from the list of activities and/or the user interface zooms and pans to an area of the animated single line diagram corresponding to the device based on stored metadata of the device.

In yet another illustrative embodiment, a computer usable program product is provided. The computer usable program products comprises a computer readable storage medium including computer usable code for a lockout tag out display, the computer usable code comprising: computer usable code for providing a user interface with the lock out tag out display, computer usable code for receiving on the user interface a design drawing of a physical space containing the device; computer usable code for creating an animated single line diagram on the user interface based on the design drawing; computer usable code for receiving a lockout tag out status instruction for the device; and computer usable code for carrying out a lockout tag out status operation on the device in the single line diagram based on the received lockout tag out status instruction.

In an illustrative embodiment, the computer usable code comprises one or more of the following; (i) computer usable code for automatically creating the animated single line diagram using pattern recognition wherein components of the design drawing are automatically recognized, and corresponding objects are chosen from a predefined database of objects to create the animated single line diagram, (ii) computer usable code for receiving an image from a user representative of an identification of said device and obtaining said identification from analysis of the image, (iii) computer usable code for animating virtual objects in the animated single line diagram by coloring, shading, reorienting, moving, or making them transparent, (iv) computer usable code for displaying virtual objects corresponding to physical devices that have been first time energized and/or energized based on stored information about energizations of the physical devices, (v) computer usable code for displaying virtual objects corresponding to physical devices that have been locked out tagged out based on stored information about lock out tag out statuses of the physical devices.

In a further illustrative embodiment, a data processing system is provided for generating a lockout tag out display. The data processing system comprises: a storage device, wherein the storage device stores computer usable program code; and a processor, wherein the processor executes the computer usable program code, and wherein the computer usable program code comprises: computer usable code for providing a user interface with the lock out tag out display; computer usable code for receiving on the user interface a design drawing of a physical space containing the device; computer usable code for creating an animated single line diagram on the user interface based on the design drawing; computer usable code for receiving a lockout tag out status instruction for the device; and computer usable code for carrying out a lockout tag out status operation on the device in the single line diagram based on the received lockout tag out status instruction.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a user drawing in which illustrative embodiments may be implemented;

FIG. 4 depicts a block diagram of an animated single line drawing in which illustrative embodiments may be implemented;

FIG. 5A depicts a block diagram of a first portion of an animated single line drawing in which illustrative embodiments may be implemented;

FIG. 5B depicts a block diagram of a second portion of an animated single line drawing in which illustrative embodiments may be implemented;

FIG. 5C depicts a block diagram of a third portion of an animated single line drawing in which illustrative embodiments may be implemented;

FIG. 6 depicts a block diagram of a first state of an animated single line drawing in which illustrative embodiments may be implemented;

FIG. 7 depicts a block diagram of a second state of an animated single line drawing in which illustrative embodiments may be implemented;

FIG. 8 depicts a front view of a camera device in which illustrative embodiments may be implemented;

FIG. 9 depicts a block diagram of a third state of an animated single line drawing in which illustrative embodiments may be implemented;

FIG. 10 depicts a block diagram of a fourth state of an animated single line drawing in which illustrative embodiments may be implemented;

FIG. 11 depicts a block diagram of a fifth state of an animated single line drawing in which illustrative embodiments may be implemented;

FIG. 12 illustrates a process for generating a lockout tag out display that shows a lockout tag out status of a device in accordance with one embodiment.

Different figures may have at least some reference numerals that may be the same in order to identify the same components, although a detailed description of each such component may not be provided below with respect to each figure.

### DETAILED DESCRIPTION

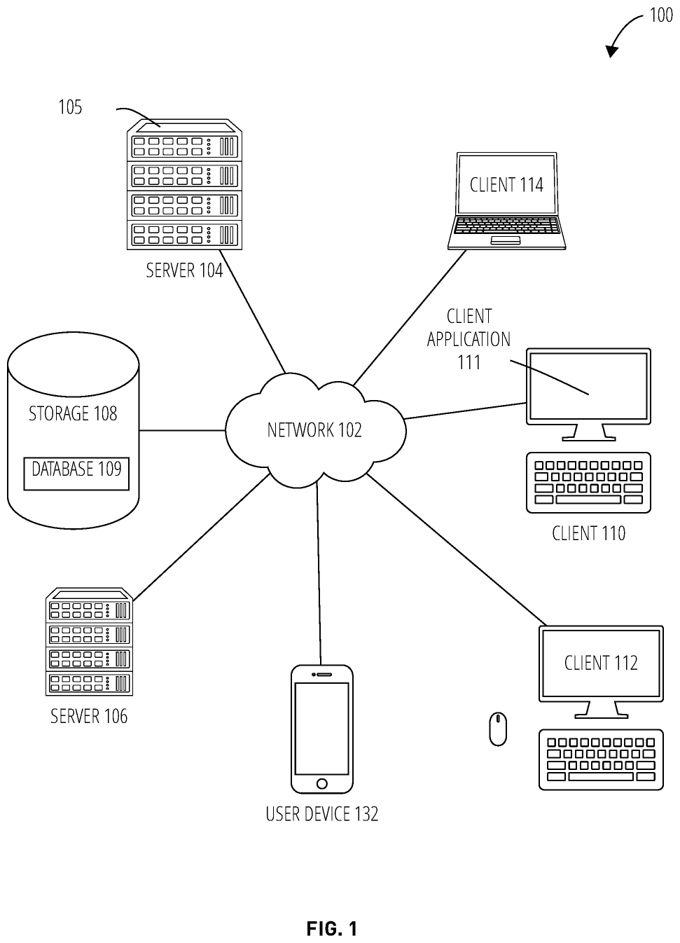

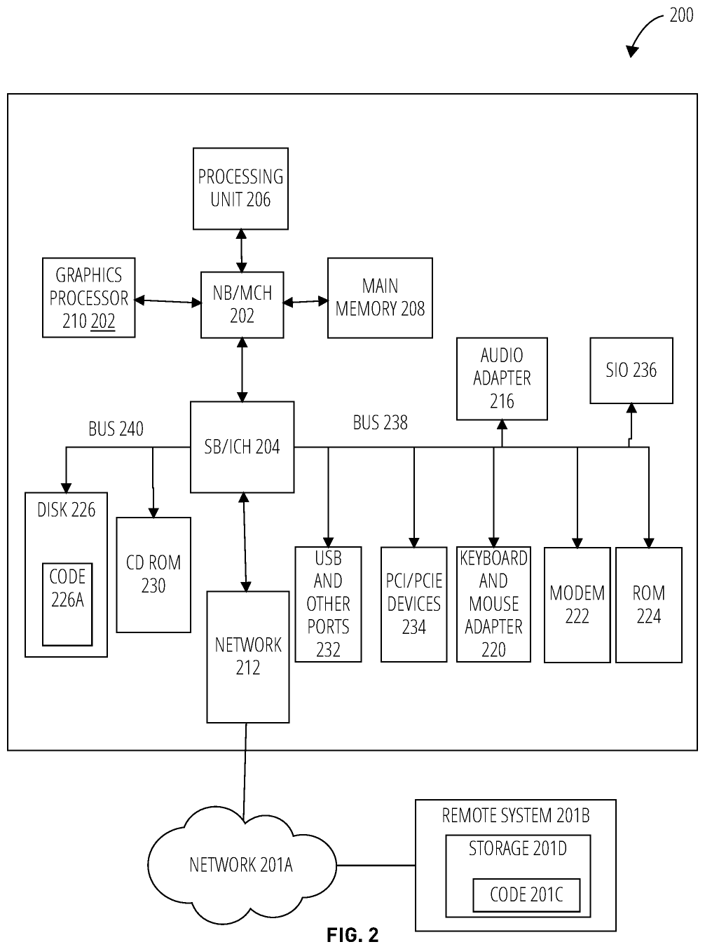

With reference to the figures and in particular with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

User device 132 is an example of a device described herein. For example, user device 132 can take the form of a smartphone, a tablet computer, a laptop computer, client 110 in a stationary or a portable form, a wearable computing device, or any other suitable device. User device 132 can be a mobile device that is used to take images of equipment that are to be locked out tagged out. Any software Application described as executing in another data processing system in FIG. 1 can be configured to execute in user device 132 in a similar manner. Any data or information stored or produced in another data processing system in FIG. 1 can be configured to be stored or produced in user device 132 in a similar manner.

An embodiment described herein can be implemented in any data processing system, such as in the form of Application 105 in server 104. Single line diagram data can be present on the server and gets loaded to all clients 110, 112, 114.

All changes made by a user to a physical equipment 806 (any mechanical or electrical equipment that generates, controls or transmits energy e.g. electrical, potential, pressure, chemical energy or the like, such as electrical panels, mechanical pumps, valves) such as the opening or closure of a breaker/valve is sent to the server. The server analyses this and processes the effect of that breaker on the data processing environment 100, allowing users to see what other equipment have been affected by the breaker/valve shut off. Various forms of Application 105 may also be implemented in clients 110, 112, 114.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an Application functions by using the interactivity between a client data processing system and a server data processing system. Data processing environment 100 may also employ a service-oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as user device 132 in FIG. 1 in which computer usable program code or instructions implementing the processes of the illustrative embodiments may be located. Data processing system 200 is described as a computer only as an example, without being limited thereto. Implementations in the form of other devices, such as user device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid-state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as Application 1o5 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIG. 1-FIG. 2 may vary depending on the implementation. Other internal hardware or peripheral devices, such as flash memory, equivalent non-volatile memory, or optical disk drives and the like, may be used in addition to or in place of the hardware depicted in FIG. 1-FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIG. 1-FIG. 2 and above-described examples are not meant to imply architectural limitations. For example, data processing system 200 also may be a tablet computer, laptop computer, or telephone device in addition to taking the form of a mobile or wearable device.

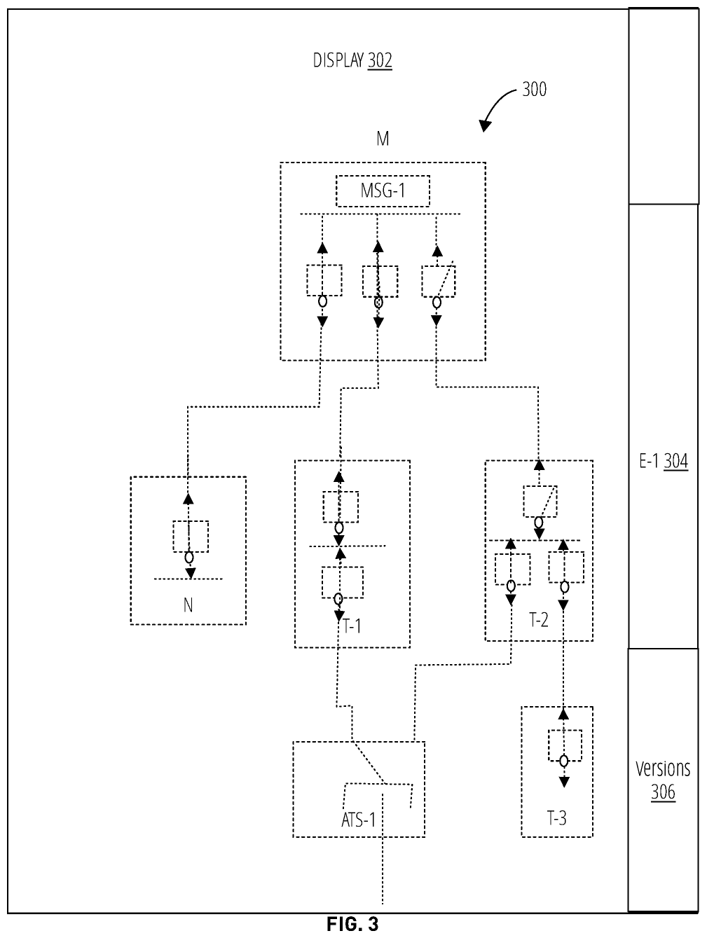

FIG. 3 depicts a block diagram of a design drawing 300 in which illustrative embodiments may be implemented. The design drawing 300 is illustrated in FIG. 3 with short dashed lines and may be a schematic file, such as in a pdf (portable document format). An animated single line diagram 400 may be created based on the design drawing 300 as explained hereinafter.

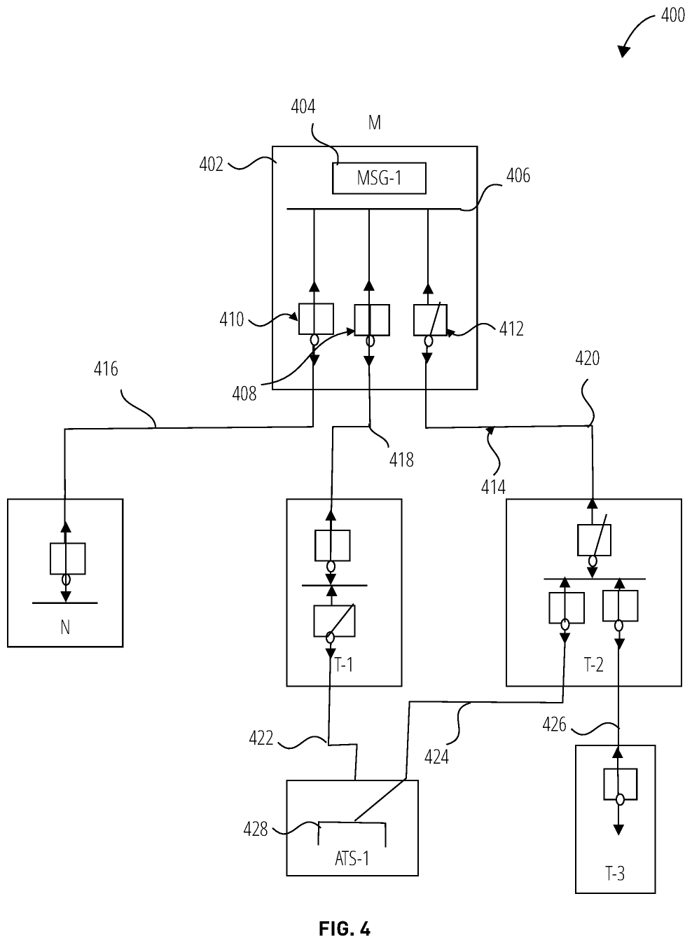

FIG. 4 depicts a block diagram of an animated single line diagram 400 of a building in which illustrative embodiments may be implemented. Though a lock out tag out process is discussed in relation to a building herein, it will be clear to a person of ordinary skill in the art in light of this specification that other systems such as mission critical facilities, data centers, chemical plants, petrochemical plants, hospitals, medical facilities, laboratories, power plants, nuclear facilities, manufacturing facilities, government facilities and any other building that may contain hazardous energy sources (such as electrical, nuclear, mechanical and potential energy) that supply power to a piece of equipment, machinery or system, are applicable.

The animated single line diagram 400 is a digital representation of physical counterparts that may show various virtual elements such as virtual equipment 402, an equipment identification (equipment ID 404), a virtual bus 406, a virtual breaker 408 (such as a virtual closed breaker 410 and a virtual opened breaker 412), a virtual connection line 414 (such as a virtual first connection line 416, a virtual second connection line 418, a virtual third connection line 420, a virtual fourth connection line 422, a virtual fifth connection line 424, a virtual sixth connection line 426) and a virtual automatic transfer switch 428.

The animated single line diagram 400 is based on a design drawing 300 (illustrated with short dashed lines) and is created manually, semi-automatically or automatically by a user and overlaid or displayed in conjunction with the design drawing 300 in a user interface 600. The processing unit 206 then controls the animated single line diagram 400 to automatically simulate the energizing (turning on/off) of physical equipment 806 in the building. A plurality of users may close or open physical breakers 810 on a plurality of physical equipment 806 and update corresponding virtual breakers 408/disconnects/switches simultaneously or at different times and the animated single line diagram 400 will be updated to show the lockout tag out statuses of the physical equipment 806 on the user interface 600 responsive to receiving updates from server 104. In addition, the cascading effect of lockouts on the energization statuses of all other equipment in the animated single line diagram 400 are computed responsive to any new lockouts and tag outs. In an illustrative embodiment, the computations are carried out on server 104 and update instructions sent to all clients 110, 112, 114, and 132.

In an illustrative embodiment, the design drawing 300 is a schematic file, such as in pdf (portable document format). In another illustrative embodiment, a floor plan and/or building information model (BIM) is displayed in addition to or in replacement of an animated single line diagram 400 wherein portions of the floor plan or building information model are animated, for example by coloring, shading, reorienting, moving, shaking, making transparent or otherwise animating, to enable users to know which areas of buildings to avoid as well as gives almost real time information about which equipment is energized. In a further illustrative embodiment, tiles (not shown) may be employed wherein an animated single line diagram 400 that contains a threshold number of virtual elements or whose area exceeds a threshold area is divided into sections or “tiles” such that each tile shows a maximum number of virtual elements that allow the virtual elements to be viewed clearly without overcrowding of said virtual elements. The tiles may be thought of as a page in a document. Thus the end of a virtual connection line in one tile may be the beginning of another virtual connection line in a subsequent tile and labels of said virtual connection lines (such as adjacent labels) may depict corresponding virtual connection lines in different tiles that are connected together.

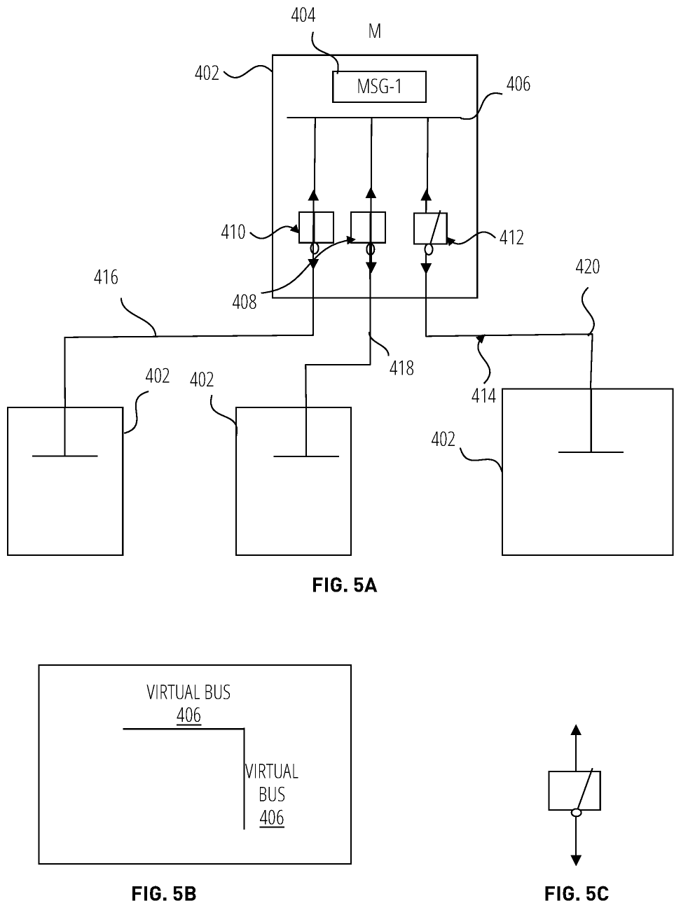

FIG. 5A depicts a block diagram of a first portion of the animated single line diagram 400 showing virtual equipment 402. The virtual equipment 402 may be connected by virtual connection lines 414. One or more virtual breakers 408 can cut off power from a virtual connection line 414 when turned off as is the case for virtual opened breaker 412. Database 109 may store properties and metadata of each virtual object in the animated single line diagram 400 such as virtual equipment 402 including energization state (for example, on or off), activity history, user access history, type of equipment, equipment ID 404, user identification (user ID), first time energization date (FTE date), first time energization user (FTE user), breaker name, breaker ID, etc. In a manual creation of the animated single line diagram 400, the user uses the design drawing 300 as a guide to place objects corresponding to components of the design drawing 300 on the user interface such that the functioning of the components is maintained. The objects include but are not limited to virtual breakers 408, virtual buses 406, virtual connection lines 414, virtual equipment 402 and virtual automatic transfer switches 428. Database 109 may also store the energization states of virtual buses 406.

In an automatic creation of the animated single line diagram 400, pattern recognition may be used to automatically create the animated single line diagram 400 using the design drawing 300. Herein components of the design drawing 300 may be automatically recognized and corresponding objects chosen from a database of objects for creating the animated single line diagram 400. The pattern recognition is achieved by the automated recognition of patterns and regularities in the design drawing 300. One approach, for example, is to use machine learning. Herein, a machine learning model is trained, for example, in a supervised technique using labelled training datasets comprising input images corresponding to known components of a design drawing 300 and their desired outputs. Through iterative optimization of an objective function, the model learns to predict the output associated with new inputs obtained from new design diagrams. Of course, other methods of pattern recognition such as through unsupervised learning, semi-supervised learning, optical character recognition (OCR), object recognition etc. may be used.

In a semi-automatic creation of the animated single line diagram 400, a combination of manual and automatic methods may be used.

FIG. 5B depicts a block diagram of a second portion of an animated single line drawing in which illustrative embodiments may be implemented. The second portion comprises a virtual bus 406 and illustrates that one virtual bus 406 can connect to another virtual bus 406. The energization state of the virtual bus 406 is stored in a database 109. When a bus is turned on, it allows energy to flow through it.

FIG. 5C depicts a block diagram of a third portion of an animated single line drawing in which illustrative embodiments may be implemented. Said third portion is a virtual breaker 408 and can be in a closed position wherein energy flows through it or in an open position wherein energy does not flow through it. The database 109 may store the breaker name and ID as well as the closed or open status of the breaker. Moreover, the database 109 may store the status, name and ID of virtual automatic transfer switches 428 shown in FIG. 4. The virtual automatic transfer switches 428 automatically switches to a new source when an original source has no energy flowing from it. It switches back to the original source once said original source gains energy (electricity). A default source may thus be set by a user. Entries in the database 109 are used to identify and/or zoom into virtual elements in animated single line diagram 400. Further, virtual connection line 414 may also have associated metadata stored in database 109. The metadata includes energization states, connection names and connection ID. Each virtual connection line 414 may connect on each side to a virtual bus 406, virtual breaker 408, virtual automatic transfer switch 428 etc. In an illustrative embodiment, energy flow logic for controlling the behavior of virtual elements in the animated single line diagram 400 are controlled by server 104 working in tandem with database 109.

In another illustrative embodiment, access to lock out devices is controlled by the software. For example, administrators can add users, project managers can create, read, update and delete (CRUD) equipment/bus/breakers/connection lines/Automatic Transfer Switches. They can also lock out tag out equipment. Field personnel can update existing equipment/bus/breakers/connection lines/Automatic Transfer Switches (ATS) and lock out tag out equipment. Readers can see all the lockout tag out status of virtual devices in the software. Thus, the embodiment can be realized as a management tool for a project by giving access to up to date information on equipment/breaker/disconnect/switch/connection statuses.

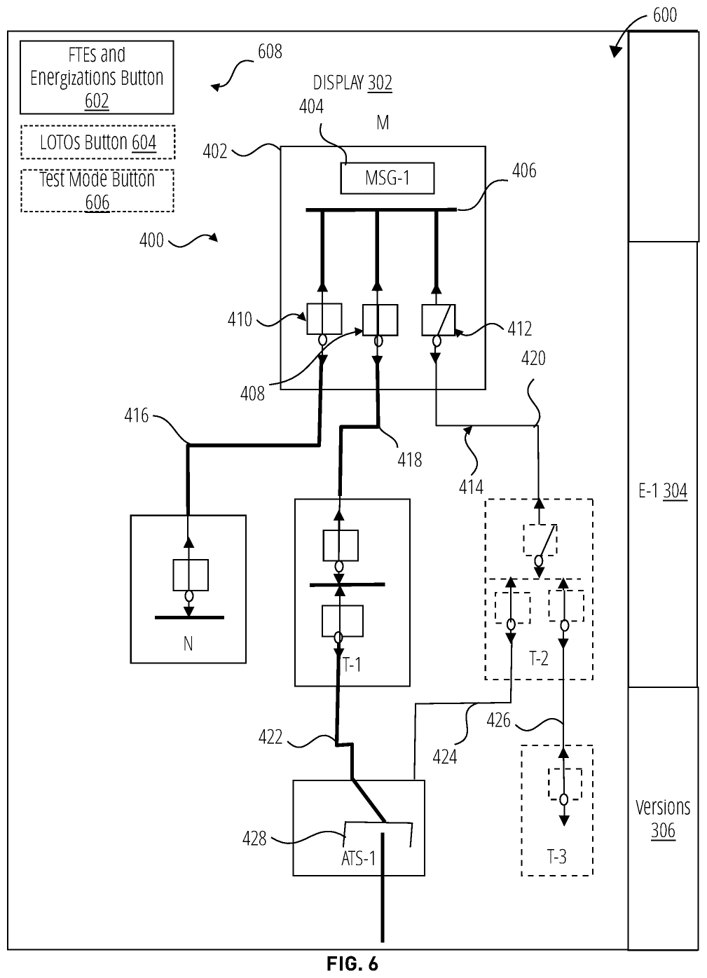

FIG. 6 depicts a block diagram of a first state of an animated single line drawing in which illustrative embodiments may be implemented.

The user interface 600 includes the animated single line diagram 400 and other objects and comprises a virtual equipment 402 (such as equipment M, N, T-1, T-2 and T-3), an equipment ID 404 configured to identify corresponding physical equipment 806, a virtual bus 406, a virtual breaker 408 (such as a virtual closed breaker 410 and a virtual opened breaker 412), a virtual connection line 414 (such as a virtual first connection line 416, a virtual second connection line 418, a virtual third connection line 420, a virtual fourth connection line 422, a virtual fifth connection line 424, a virtual sixth connection line 426), a virtual automatic transfer switch 428, a Display 302, toggle buttons 608 (such as an FTEs and Energizations Button 602, a LOTOs Button 604, a Test Mode Button 606), design drawing 300 (such as Drawing E-1 304), and design drawing versioning (such as Drawing Versions 306 which can indicate the newest design drawing version that corresponds to the animated single line diagram 400).

The animated single line diagram 400 is displayed in the user interface 600 preferably overlaid on the design drawing 300 which can be activated by selecting the drawing, in this case (Drawing E-1 304). The animated single line diagram 400 is configured to track first time energizations of physical equipment 806 as well as all energizations of the physical equipment 806. The physical equipment 806, physical lock 808, physical breaker 810, physical breaker lockout 812 are represented virtually in the user interface 600 respectively as virtual equipment 402, virtual lock 702, virtual breaker 408, virtual breaker lockout (not shown).

The animated single line diagram 400 is also configured to track all lock out tag outs, for example, every breaker lock out tag out in an electrical project as well as every valve lockout tag out in a mechanical project. This is achieved visually by using the design drawing 300 to create the animated single line diagram 400 and obtaining lockout tag out status instructions from server 104 to update/animate the animated single line diagram 400. In user interface 600 toggle buttons 608 are used to enable the display of first time energizations and other energizations (FTEs and Energizations Button 602), lock out tag outs (LOTOs Button 604) and test modes (Test Mode Button 606, for authorized users such as project managers to test how device activation and deactivations would affect other objects shown upstream and downstream in the animated single line diagram 400).

FIG. 6 utilizes various line types to illustrate animations. For example, solid lines are used for some toggle buttons 608 to illustrate that the FTEs and Energizations Button 602 is enabled, while using short dashed lines for other toggle buttons 608 to show that buttons LOTOs Button 604 and Test Mode Button 606 are disabled. In the software, the FTES and Energizations Button 602 and disabled toggle buttons 608 may be colored red and gray respectively as a differentiator. Thick virtual connection lines 414 (virtual first connection line 416, virtual second connection line 418) are also used, for example, illustrate lines that have energy passing through, while thin virtual connection lines 414 (virtual third connection line 420) illustrate lines that have no energy passing through them. Animated single line diagram 400 also uses solid lines to show all objects in the animated single line diagram 400 that have been first time energized or energized, since the FTEs and Energizations Button 602 is the only button enabled. Long dashed lines in the animated single line diagram 400 are used to illustrate objects that do not correspond to the activated button FTEs and Energizations Button 602. Of course, other buttons and associated logic can be realized by persons of ordinary skill in the art in light of the specification.

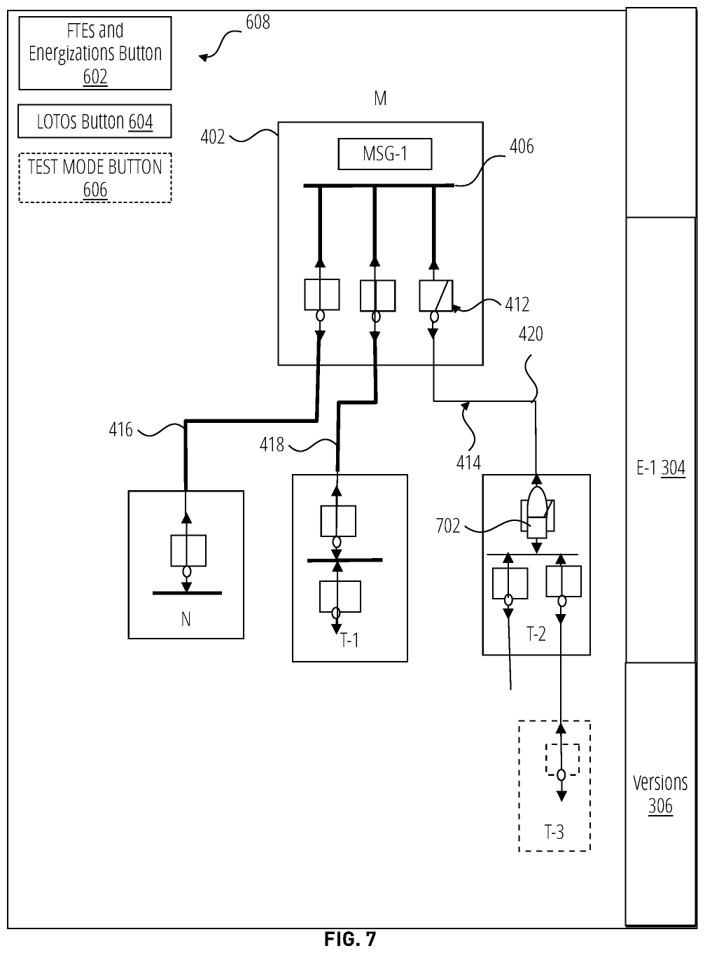

FIG. 7 depicts a block diagram of a second state of an animated single line drawing in which illustrative embodiments may be implemented. It can be seen that the FTEs and Energizations Button 602 and LOTOs Button 604 are activated. Similarly, to FIG. 6, equipment M, N and T-1 are animated according to logic of the FTES and Energizations Button 602 as shown by the thick virtual first connection line 416 and virtual second connection line 418. When a user decides to lock a device (which may be, for example, a breaker/disconnect/switch/valve) the user may place a physical lock 808 on a physical equipment 806 corresponding to virtual equipment 402 (in this case equipment T-2). Lockout tag out status Instructions are then generated by the server 104 and sent to all clients for update. Upon receiving the lockout tag out status instructions, said lockout tag out status instruction including an identification of the device or equipment being locked out, the client's user interface 600 is updated to place a virtual lock 702 on the virtual object corresponding to the locked out device or equipment as shown in FIG. 7. Thus, when the LOTOs Button 604 is activated, all locked out devices in the user interface 600 are correspondingly animated by, for example, placing the virtual lock 702 on the locked out device in the animated single line diagram 400. This introduced an improved level of trust in the system as proper functioning of equipment can be readily verified in a non-time-consuming manner. Moreover, errors from conventional systems are substantially reduced or eliminated. In an illustrative embodiment, the physical lock 808 is only removed by an original user who placed the lock onto the breaker, as is the case with standard lock out tag out practice.

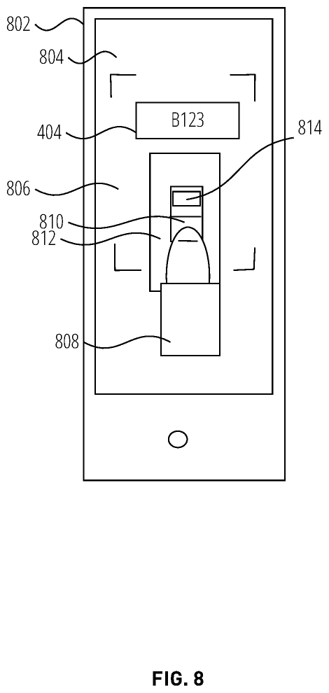

FIG. 8 depicts a front view of a mobile device 802 in which illustrative embodiments may be implemented.

A physical lock 808 is used to lock the physical equipment 806 by for example, turning a physical breaker into an off position, placing a physical breaker lockout 812 on a physical breaker 810 of the physical equipment 806 and locking said physical breaker 810 through use of the physical breaker lockout 812 and physical lock 808. A viewfinder 804 of the mobile device 802 is used to take an image of the physical equipment 806 which has an equipment ID 404. The mobile device 802 may be a user device 132. The image can thus be sent to the server 104. Moreover the user can turn off and lock the virtual breaker corresponding to the locked physical breaker 810 in the user interface 600 of the mobile device 802 and said turning off activity, including user name, time, or the like can be reported to the server 104 in order to update all clients. In an illustrative embodiment, pattern recognition, such as text recognition of the equipment ID 404 or breaker number 814 is carried out on the server 104 through analysis of an image taken by the mobile device 802. Said analysis can be achieved on server 104 using the image as input, said image and/or other metadata of the physical equipment 806 being transferred to the server, for example wirelessly. To compute lockout tag out status instructions for clients, the server 104 detects the lockout status choice and name of the breaker from received input, locates said breaker in the animated single line diagram 400, loads logic instructions about energy flow in the animated single line diagram 400 and calculates upstream and downstream energy flow using said one or loaded instructions. The lockout status of the physical breaker lockout 812 is also reflected on the corresponding virtual breaker 408. In an illustrative embodiment, one energy flow logic may be: no energy flows to a virtual connection line 414 in electrical connection through any breaker that is turned off. Ideally, the energy flow logic mimics how energy flows through corresponding physical devices (e.g. How electricity flows through electrical components in an electrical circuit).

In an illustrative embodiment, a user always takes an image of a device to be locked out tagged out to ensure that proof exists about said device being locked out tagged out. Said image can be utilized in the animated single line diagram 400 for verification purposes. In an illustrative embodiment, the user interface 600 allows a virtual equipment to be marked to stay in the on position such that if a user attempts to turn off a physical breaker that affects the physical equipment corresponding to said virtual equipment, the software returns an error message and thus does not give said user permission to turn off the breaker in order to update said turning off on all clients. A log of all actions and messages are ideally stored for historical purposes to keep track devices that have been properly and/or improperly turned on or off.

In another illustrative embodiment the software is expanded to communicate with other APIs such construction and facility management software. It can also be used to track other information of the equipment and report said other information ideally in a graphical manner through the floor plan and/or the building information model. The software can also become a commissioning issue tracking software to visually display and track commissioning status.

In an alternative embodiment, the physical devices communicate directly with the server 104 through, for example, wireless communication, without going through the mobile device 802. This can be achieved by sensors such as wireless enabled sensors configured to measure changes in energy flowing through corresponding physical devices. Thus, for example, if a device is energized or locked out tagged out, without using an approved flow of the software, it can be made known. In an illustrative embodiment, sensors such as RFID (Radio Frequency Identification) tags are incorporated into physical devices for monitoring. Responsive to being triggered by an electromagnetic interrogation pulse from a nearby RFID reader device, or at regular intervals, the tag transmits digital data, identifying the physical device, such as device ID, power status, device location, or otherwise physical device information, to the reader device. The transmission may be wireless. Said reader device can be configured to be in wireless communication with the server 104, such as an application on server 104, and may send said physical device information to the server 104 for further processing such as to the animated single line diagram 400. Herein the RFID tag and reader may be used in tandem with a human user.

In another illustrative embodiment, images of locked out tagged out devices are displayed in the user interface 600 upon request. In yet another illustrative embodiment, the system is used to map out existing buildings and facilities such as hospitals, universities and factories an update to their single line diagrams or for renovating or managing the facilities. Herein, user walks up to a device such as a breaker and acquires an image of the human readable breaker number/text identification. The software finds the breaker within the drawings and allows user to perform a lock out tag out within the software. If user is trying to operate a device/breaker/disconnect/switch that is not authorized, said software returns an error and said user is not allowed to proceed. Further, by using stored logic and metadata about virtual objects in the animated single line diagram, a user can query all devices that fit a defined criterion (for example, all power sources). Server 104 performs a search through database 109 for objects whose metadata correspond to power sources according to a predefined energy flow logic and returns said objects to the user. Alternatively, when the user searches for an equipment by name, it may also be searched in a local database.

In an alternate embodiment, the animated single line diagram 400 is configured to simulate current flow, or amount of voltages in each equipment

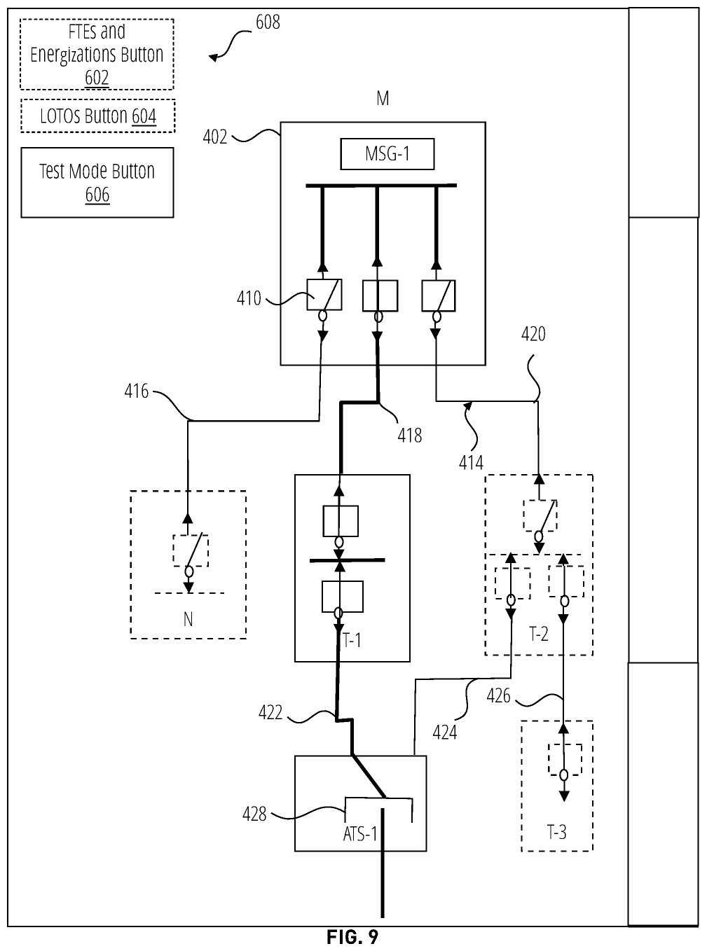

FIG. 9 depicts a block diagram of a third state of an animated single line drawing in which illustrative embodiments may be implemented. In FIG. 9, a Test Mode Button 606 is shown as being activated. Herein by turning virtual closed breaker 410 from an on position to an off position in the test mode, equipment N is deactivated, leaving equipment M, T-1 and virtual automatic transfer switch 428 to be activated in the animated single line diagram 400. In the test mode, all changes to the animated single line diagram 400 are ideally done locally on the user device and are not communicated to server 104. Further, a different animation is ideally used for test modes to visually differentiate the test mode from other modes. In an illustrative embodiment of the various states of the animated single line diagram, a bus can be simulated as being a power source (such as receiving power from a utility) thus allowing a person to show power in an equipment without having to create complex single line diagrams all the way up to the utility.

Thus, the software is a central repository of lock out and tag out information, energization status, equipment information, commissioning level and issue information for every piece of equipment that a user wants to track in a building. When a change of energy status is made, the change is reported to all of the project stakeholders.

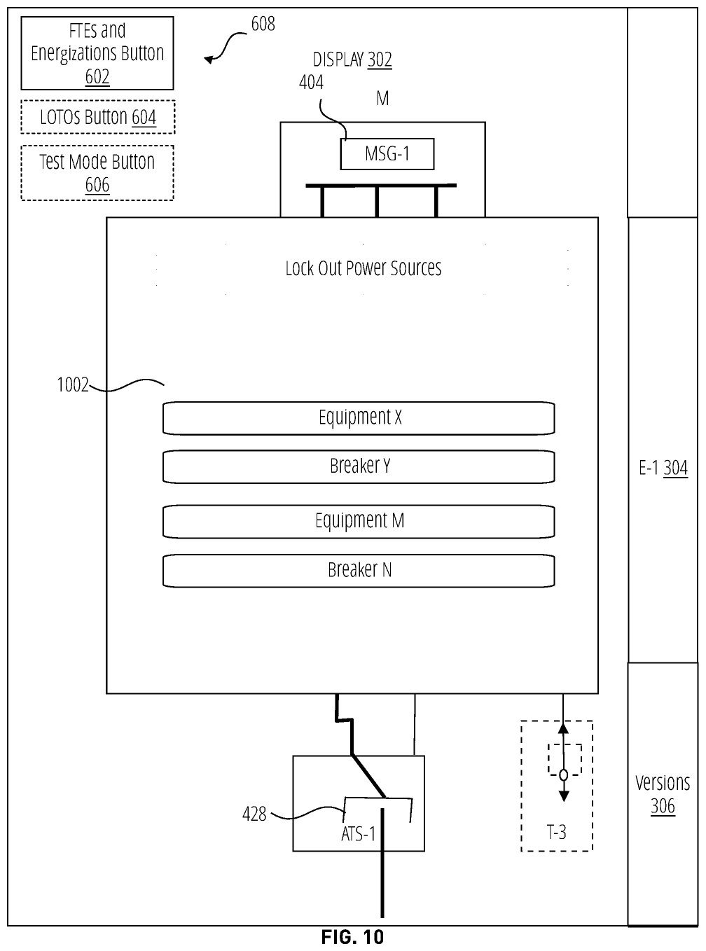

FIG. 10 depicts a block diagram of a fourth state of an animated single line drawing in which equipment affected by a lock out tag out process are displayed. Herein, by using a defined energy flow logic and changes in stored energy statuses of objects in the animated single line diagram 400 prior to the lock out tag out process, the user interface 600 shows a list of all devices/power sources that need to be shut off for the lock out tag out to happen. The user interface may also be configured to locate a position of any of the devices in the list upon a navigate button 1002 being selected, by using metadata of the selected device as a search criterion. Thus, the user may select an equipment and the device will zoom and pan to the equipment location. In an illustrative embodiment, when a user to locks out tags a breaker, the software searches for all of that breaker's power sources. It then lists those power sources for the user to see and allows the visual opening or automatic zooming to each power source (breaker) so said user can lock out tag out each one.

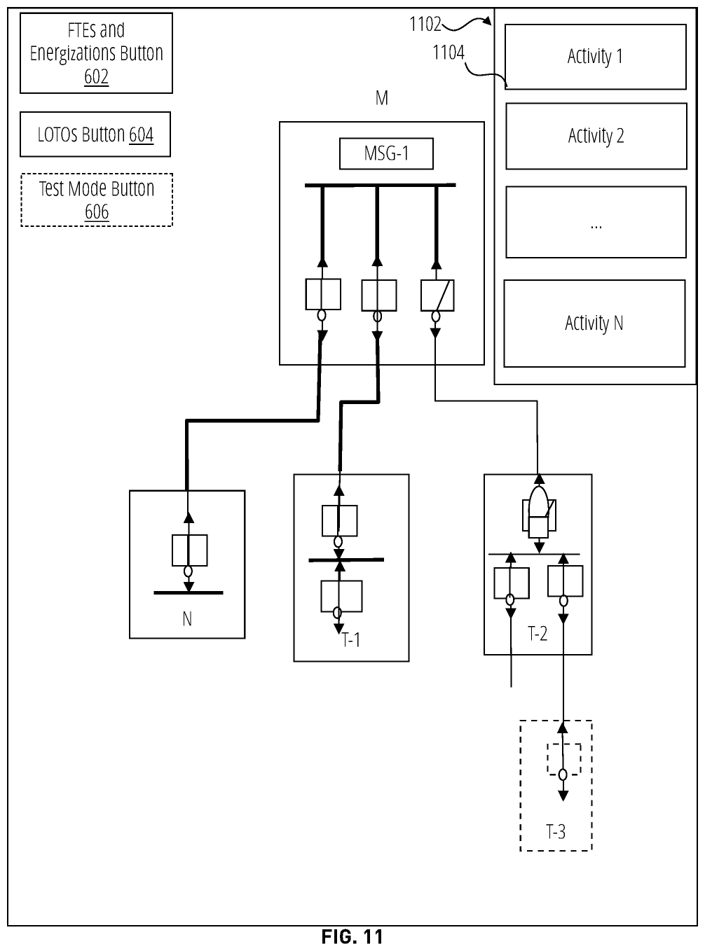

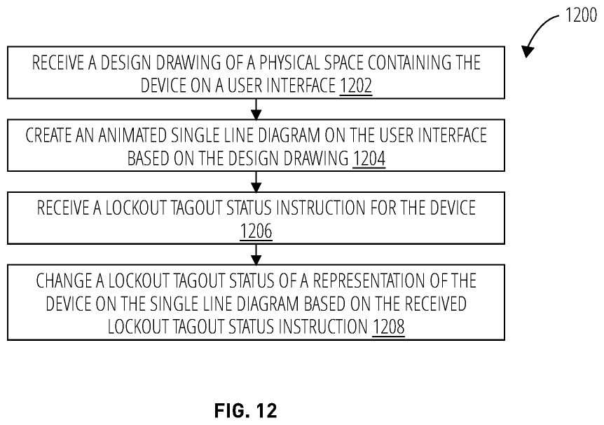

FIG. 11 depicts a block diagram of a fifth state of an animated single line drawing in which other search results may be implemented.

Search results can be based on user preference. For example, maybe user wants to see all activity of another defined user or all first time energizations. By allowing said user to search any input, stored metadata produced during creation of the animated single line diagram 400 or during updating of the animated single line diagram 400 can be searched and results displayed in the user interface. In an illustrative embodiment, if an incident did occur, one can easily find out if a device/breaker/equipment was locked out tagged out in the software properly by searching the activity log. FIG. 11 shows returned activity log 1102 and corresponding activities 1104. The user interface is configured to zoom and pan to corresponding objects in the animated single line diagram 400 or floor plan or building information model when said activities 1104 are selected.

In Step 1202, Process 1200 receives a design drawing of a physical space containing the device on a user interface. In Step 1204, Process 1200 creates an animated single line diagram on the user interface based on the design drawing. The user interface 600 gives users the opportunity to check against the animated single line diagram 400 as they perform an action such as lock out tag out. This solution is ideally structured so that looking at the single line diagram is part of the process of lock out tag out.

In Step 1206, Process 1200 receives a lockout tag out status instruction for the device. In Step 1208, Process 1200 changes a lockout tag out status of a representation of the device on the single line diagram based on the received lockout tag out status instruction. Thus, a computer implemented method is produced for lock out tag out control.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for generating a lockout tag out display, the method comprising;
providing a user interface with the lock out tag out display;
receiving on the user interface a design drawing of a physical space containing the device;
creating an animated single line diagram on the user interface based on the design drawing;
receiving a lockout tag out status instruction for the device; and
carrying out a lockout tag out status operation on the device in the single line diagram based on the received lockout tag out status instruction.

2. The computer implemented method of claim 1 wherein a server distributes said lockout tag out status instruction to a plurality of clients.

3. The computer implemented method of claim 1 wherein the animated single line diagram is created automatically using pattern recognition wherein components of the design drawing are automatically recognized and corresponding objects are chosen from a predefined database of objects to create the animated single line diagram.

4. The computer implemented method of claim 1 wherein the animated single line diagram is created manually by identifying components of the design diagram and selecting corresponding objects from a predefined database of objects to create the animated single line diagram.

5. The computer implemented method of claim 1 wherein the animated single line diagram is created semi-automatically by a combination of manual and automatic steps.

6. The computer implemented method of claim 1, further comprising receiving an image from a user representative of an identification of said device and obtaining said identification from analysis of the image.

7. The computer implemented method of claim 1, wherein the animated single line diagram is overlaid on the design drawing.

8. The computer implemented method of claim 1, further comprising: computing an effect of the lockout tag out status operation on other devices upstream and downstream of the device based on defined energy flow logic.

9. The computer implemented method of claim 1, wherein virtual objects in the animated single line diagram are animated by coloring, shading, reorienting, moving, or making them transparent.

10. The computer implemented method of claim 1, further comprising displaying virtual objects corresponding to physical devices that have been first time energized and/or energized based on stored information about energizations of the physical devices.

11. The computer implemented method of claim 1, displaying virtual objects corresponding to physical devices that have been locked out tagged out based on stored information about lock out tag out statuses of the physical devices.

12. The computer implemented method of claim 1, further comprising providing a test mode for the user interface wherein changes to virtual objects of the animated single line diagram are controlled on a local user interface.

13. The computer implemented method of claim 1, wherein a sensor coupled to the physical device is configured to transmit information about the physical device to the server for updating the animated single line diagram.

14. The computer implemented method of claim 1, further comprising providing a list of activities and/or devices that match a user search criteria, wherein responsive to selecting an activity and/or device from the list of activities and/or the user interface zooms and pans to an area of the animated single line diagram corresponding to the device based on stored metadata of the device.

15. A computer usable program product comprising a computer readable storage medium including computer usable code for a lockout tag out display, the computer usable code comprising:
computer usable code for providing a user interface with the lock out tag out display;
computer usable code for receiving on the user interface a design drawing of a physical space containing the device;
computer usable code for creating an animated single line diagram on the user interface based on the design drawing;
computer usable code for receiving a lockout tag out status instruction for the device; and
computer usable code for carrying out a lockout tag out status operation on the device in the single line diagram based on the received lockout tag out status instruction.

16. The computer usable program product of claim 15, further comprising:
computer usable code for automatically creating the animated single line diagram using pattern recognition wherein components of the design drawing are automatically recognized, and corresponding objects are chosen from a predefined database of objects to create the animated single line diagram.

17. The computer usable program product of claim 15, further comprising:
computer usable code for receiving an image from a user representative of an identification of said device and obtaining said identification from analysis of the image.

18. The computer usable program product of claim 15, further comprising:
computer usable code for animating virtual objects in the animated single line diagram by coloring, shading, reorienting, moving, or making them transparent.

19. The computer usable program product of claim 15, further comprising:
computer usable code for displaying virtual objects corresponding to physical devices that have been first time energized and/or energized based on stored information about energizations of the physical devices.

20. A data processing system for generating a lockout tag out display, the data processing system comprising:
a storage device, wherein the storage device stores computer usable program code; and
a processor, wherein the processor executes the computer usable program code, and
wherein the computer usable program code comprises:
computer usable code for providing a user interface with the lock out tag out display;
computer usable code for receiving on the user interface a design drawing of a physical space containing the device;
computer usable code for creating an animated single line diagram on the user interface based on the design drawing;
computer usable code for receiving a lockout tag out status instruction for the device; and
computer usable code for carrying out a lockout tag out status operation on the device in the single line diagram based on the received lockout tag out status instruction.
